(19) United States
(12) Patent Application Publication
(10) Pub. No.: US 2005/0067788 A1
(43) Pub. Date: Mar. 31, 2005

(54) Outer air seal assembly

(75) Inventor: George Liang, Palm City, FL (US)

Correspondence Address: Siemens Corporation;Intellectual Property Department, 170 Wood Avenue South, Iselin, NJ, 08830, US

(73) Assignee: Siemens Westinghouse Power Corporation

(21) Appl. No.: 10/671,291

(22) Filed: Sep. 25, 2003

(51) Int. Cl. F16J 15/44

(52) U.S. Cl. 277/409

(57) ABSTRACT

An outer air seal assembly for use around rotating fluid guide components, such as rotating blades within a turbine engine, is disclosed. The seal includes features that reduce radially-directed leakage while increasing operational life of the seal and providing additional turbine section cooling without reducing engine performance. The seal employs boundary members that cooperatively prevent leakage within the turbine section of an associated gas turbine engine. The boundary members are spaced apart by interface gaps having radially-skewed portions that protect blocking panels disposed within the gap and extends the life of seal. The interface gap may also include a radially-aligned portion, and partition members may extend into the gap to form a flow-slowing serpentine-shaped pathway within the gap. Conduits disposed within the boundary members allow cooling fluid to enter the interface gap, providing supplemental cooling benefits without reducing engine operating efficiency. Multiple sets of boundary members may be used in an axially-extending orientation, with interface gaps being disposed between boundary members of each set.

### FIELD OF THE INVENTION

This invention relates generally to the field of internal to combustion engines and, more particularly, to an outer air seal having leakage-reducing and cooling-enhancing features.

### BACKGROUND OF THE INVENTION

Combustion engines are machines that convert chemical energy stored in fuel into mechanical energy useful for generating electricity, producing thrust, or otherwise doing work. These engines typically include several cooperative sections that contribute in some way to the energy conversion process. In gas turbine engines, air discharged from a compressor section and fuel introduced from a fuel supply are mixed together and burned in a combustion section. The products of combustion (also referred to as the working gas or working fluid) are harnessed and directed through a turbine section, where they expand and turn a central rotor shaft. The rotor shaft may, in turn, be linked to devices such as an electric generator to produce electricity.

To increase the power production capacity of gas turbine engines, efforts are often made to maximize the amount of energy extracted by the turbine section. A number of strategies have been developed to help in this regard. One strategy is to operate the combustion section at an elevated temperature, typically near the operational limits of the engine components, to impart large amounts of potential energy to the working fluid. Another strategy includes employing seals to increase engine efficiency by reducing leakage of working fluid into non-energy-converting portions of the engine. In yet another strategy, the design of the turbine section fluid guide components, such as blades and vanes, may be optimized to produce high-yield interaction between the components and the working fluid. Each of these strategies has advantages and disadvantages, and the strategies may be combined to fit various situations and operating conditions.

In situations where turbine section seals are used, a variety of difficulties may be encountered. For example, to accommodate the growth and shrinkage produced by temperature cycling during engine operation, seals often fit loosely during low-load operating conditions and allow leakage in all but the most extreme environments. Turbine seals may also store heat, producing unwanted increases in engine cooling requirements and actually reducing engine efficiency. Accordingly, there remains a need in this field to improve seal performance.

### SUMMARY OF THE INVENTION

The present invention is an outer air seal assembly for use around rotating fluid guide components, such as turbine blades, within a gas turbine engine. The seal includes features that reduce radially-directed leakage while increasing operational life of the seal and providing additional turbine section cooling without reducing engine performance.

The component includes boundary members that cooperatively prevent leakage within the turbine section of an associated gas turbine engine. The boundary members are spaced apart by interface gaps, with the gaps including a radially-skewed portion that protects blocking panels disposed within the gap and extends the life of seal. The interface gap may also include a radially-aligned portion, and partition members may extend into the gap to form a flow-slowing serpentine-shaped pathway within the gap. Conduits disposed within the boundary members allow cooling fluid to enter the interface gap, providing supplemental cooling benefits without reducing engine operating efficiency.

Other advantages of this invention will become apparent from the following description taken in conjunction with the accompanying drawings wherein are set forth, by way of illustration and example, certain embodiments of this invention. The drawings constitute part of this specification and include exemplary embodiments of the present invention and illustrate various objects and features thereof.

### BRIEF DESCRIPTION OF THE DRAWING

FIG. 1 is a side plan view of an engine using the outer air seal of the present invention;

FIG. 2 is an end view of the outer air seal of the present invention in use within the engine turbine section shown in FIG. 1

FIG. 3 is a partial elevation view of two cooperating boundary members of the present invention; and

FIG. 4 is partial plan view of the boundary members shown in FIG. 3, with no blocking panel installed.

### DETAILED DESCRIPTION OF THE INVENTION

Reference is made to the Figures, generally, in which an outer air seal 10 according to the present invention is shown. By way of overview, the seal 10 includes a set 20 of boundary members 12 grouped in a ring-shaped arrangement to prevent leakage within the turbine section 16 of an associated gas turbine engine 18. Each boundary member 12 is separated from adjacent boundary members by interface gaps 22 formed therebetween. The interface gaps 22 allow contraction and expansion of individual boundary members 12, as well as relative motion between the boundary members, collectively, during operation. The interface gap 22 includes a radially-skewed portion 24 formed by angled portions 26,28 of cooperating, adjacent boundary member interface edges 30,32. The interface gap 22 may also include a radially-aligned portion 34, and one or more partition members 36 may extend into the interface gap 22 to form a serpentine-shaped pathway 38 within the gap. Cooling fluid conduits 40 disposed within the boundary members 12 provide a pathway for cooling fluid 42 to enter the interface gap 22, thereby providing supplemental cooling without reducing engine operating efficiency. It is noted that while the outer air seal 10 is described in the context of an industrial gas turbine engine 18, and specifically within an engine turbine section 16, the seal will provide benefits in other settings, including other stationary interfaces such as inter-vane interfaces and end wall to downstream component interfaces, as well. Furthermore, as a matter of convention, rotation of blades 14 will be shown as occurring in a counter-clockwise fashion during operation of the reference engine 18. Clockwise rotation is possible, however, and in settings with clockwise rotation, the various aspects of the invention would be achieved most-effectively if the orientation of the radially-skewed portion 24 of the interface gap 22 is commensurately reversed from that shown and described herein. Additionally, in the context of counter-clockwise rotation, the terms “rotationally-upstream” and “rotationally-downstream” shall refer to locations that are displaced, respectively, clockwise and counter-clockwise from a given reference point. The outer air seal 10 of the present invention will now be described in detail.

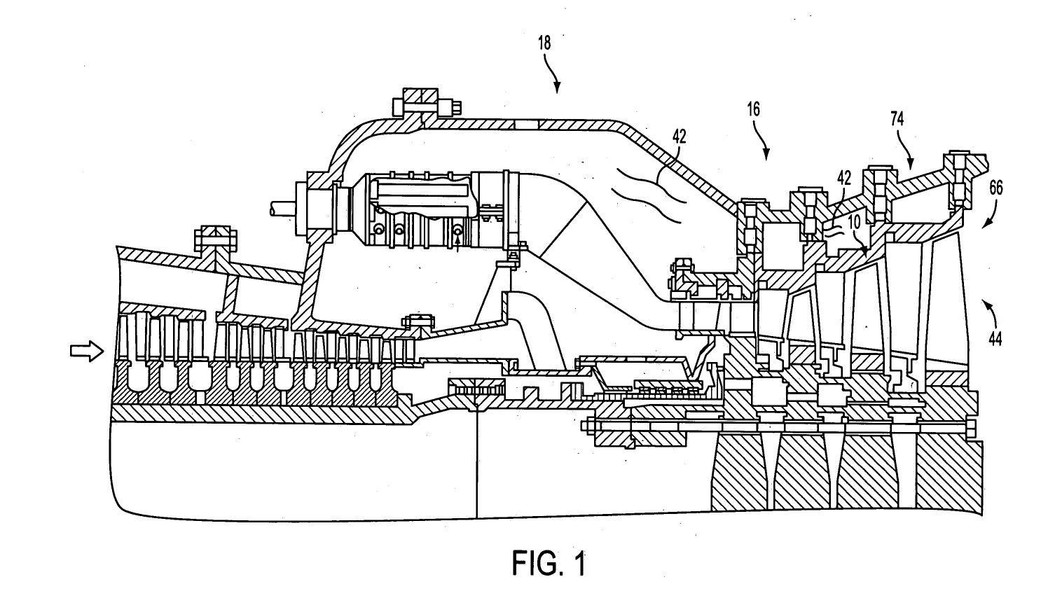

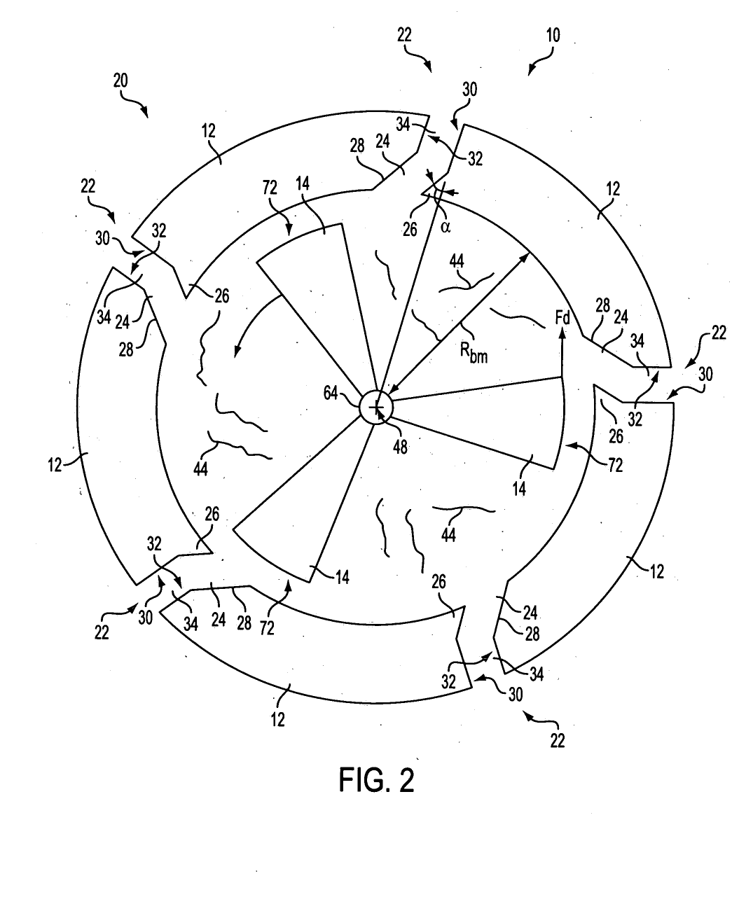

As seen with particular reference to FIGS. 1 and 2, and as noted above, the outer air seal 10 of the present invention incorporates several boundary members 12 grouped in a ring-shaped arrangement to reduce unwanted leakage of working fluid 44 out of the turbine section 16 of an industrial gas turbine engine 18. More particularly, the boundary members 12 are disposed proximate to, but radially-outward-of the turbine section blades 14. In the present embodiment, the boundary members 12 are identical and located at a uniform radial distance Rbm from a central axis 48. It is noted that while the present discussion is directed to an arrangement of uniform boundary members 12, arrangements involving non-uniform boundary members would also suffice.

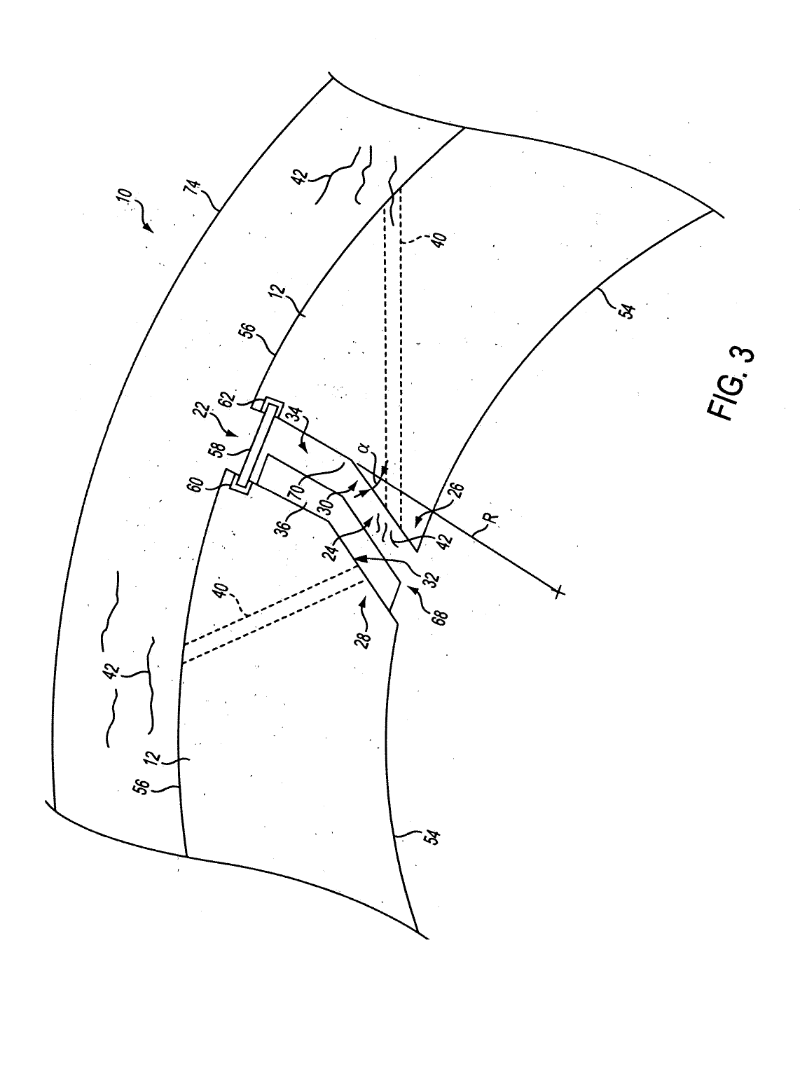

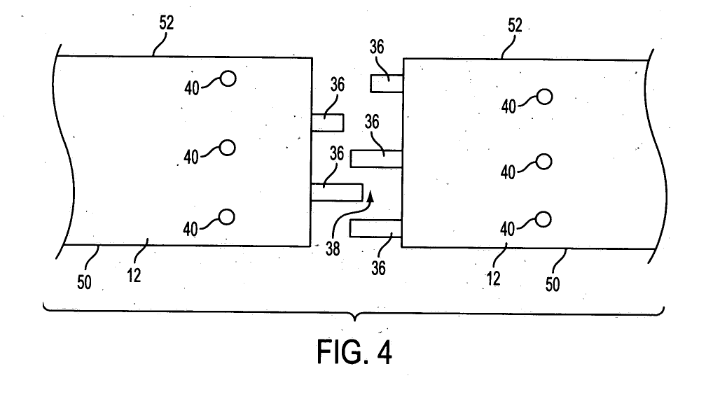

As seen with continued reference to FIG. 2, and with additional reference to FIGS. 3 and 4, the boundary members 12 are essentially-rectangular elements that cooperatively form a substantially-continuous band adapted for encircling a longitudinally-extending region within the turbine section 16. The boundary members 12 include a front edge 50 and a rear edge 52 that each extend between the interface edges 30,32 noted above. The boundary members 12 have a curved cross-section characterized by a radially-inward surface 54, which is oriented toward the engine central axis 48, and an opposite, radially-outward surface 56. The interface edges 30,32 of adjacent boundary members 12 have complementary contours. As noted above, interface edges of adjacent boundary members form interface gaps 22 that allow relative motion, as well as cyclic growth and contraction, of the boundary members during engine operation. Although not required, the present embodiment also includes a radially-aligned portion 34 disposed proximate the boundary member radially-outward surface 56. A blocking panel 58 disposed within the interface gap 22 provides a physical barrier that helps prevent unwanted, radially-outward motion of working fluid 44 traveling through the turbine section 16. Blocking panels 58 may be omitted in settings where additional fluid flow obstructions are not desired. Where used, however, the panels 58 may be held in place by a variety of methods, such as notches 60,62 cut into the boundary member interface edges 30,32. Other fixing methods, including welding, brazing, interference fits, and the use of fastening components may also hold the panels 58 in place, if desired. As will be more fully described below, the interface gap 12 of the present invention also provides extended component life by reducing pulse loading of blocking panels 58. Although the radial position of the blocking panels 58 may vary, the panel protection feature described below is most effective when the blocking panel 58 is located radially outward of the radially-skewed portion 24. In this application, the term “radially-skewed” means an orientation that is rotated to be offset from a radial orientation by a desired amount. In the present embodiment, the radially-skewed portion of the interface gap 22 is offset from radial orientation by an angle α Within the range of about fifteen to fifty-five degrees. It is noted that the radially-skewed portion 24 need not be proximate the radially-inward surface 54 of the boundary members 12; however, shifting the radial position of the radially-skewed portion may reduce the film cooling feature described below.

With continued reference to FIGS. 3 and 4, an exemplary interface gap 22 will now be described. The radially-skewed portion 24 of the interface gap 22 is disposed proximate the boundary member radially-inward surface 54 and is characterized by a radially-inward region 68 and a radially-outward region 70. In keeping with various aspects of the invention, the radially-outward region 70 of the radially-skewed portion 24 is located rotationally-upstream of the radially-inward region 68.

During operation, working fluid 44 traveling through the turbine section 16 strikes the turbine blades 14 and imparts rotational motion to the turbine shaft 64. As the turbine shaft 64 spins and the turbine blades 14 continue to rotate, working fluid 44 travels in a substantially-helical path toward the turbine section exit 66, shown in FIG. 1.

As the blades 14 rotate, the associated blade tips 72 sweep cyclically past the various interface gaps 22. Working fluid 44 guided by the blade tips 72 is directed toward the boundary members 12 and flows in a pulse-like manner into the interface gaps 22. In the present embodiment, the radially-skewed portion 24 of the interface gap 22 is oriented substantially-perpendicular to the direction (F_{d}) of working fluid 44 guided by the blade tips as it reaches the interface gaps 22. With this arrangement, the radially-skewed portion 24 of the interface gap 22 changes the direction of working fluid 44 pulses, thereby reducing their velocity within the interface gap 22 and lessening the impact upon blocking panels 58 disposed within the gap. This arrangement allows the engine 18 to operate for longer periods before blocking panel 58 replacement is required. It is noted that other configurations of radially-skewed interface gap portions 24 may suffice to redirect the pulse loading tendencies of working fluid 44 being swept into the interface gaps 22, including arrangements in which several angles of inclination are produced within the gap or in which the sections of the skewed portion are aligned with, or only slightly-offset from, the pulses of working fluid.

With reference to FIG. 4, the partition members 36 which, as noted above, extend into the interface gaps 22 will now be described. In this embodiment, the outer air seal 10 of the present invention includes a serpentine-shaped pathway 38 disposed within one or more interface gaps 22; the pathway is formed with partition members 36 that extend from the interface edges 30,32. In the embodiment shown in FIG. 4, the partition members 36 are arranged in a substantially-radial alignment and are especially effective to slow longitudinal progress of working fluid 44 through the interface gap 22. As shown in FIG. 4, the partition members 36 extend substantially the entire distance between the boundary member radially-inner and radially-outer surfaces 54,56; the partition members may extend only a portion of that distance, if desired, however. It is noted that the partition members 36 may also be oriented with a substantially-circumferential alignment (not shown) to inhibit radially-directed flow of working fluid 44 through the interface gap 22. It is further noted that various combinations (not shown) of partition member 36 alignments may also be used. Moreover, partition members 36 need not be used in settings where supplemental fluid flow restriction is not desired.

With reference to FIGS. 3 and 4, the cooling fluid conduits 40, which, as noted above, provide a pathway for cooling fluid 42 to enter the interface gaps 22, will now be described. In this embodiment, the outer air seal 10 of the present invention includes cooling fluid conduits 40 that link the interface gap 22 with a source of cooling fluid 42, such as shell air-located radially-between the boundary members 12 and the outer boundary 74 of the turbine section 16. With particular reference to FIG. 3, the cooling fluid conduits 40 extend from the radially-outward surfaces 56 of the boundary members 12 to the radially-skewed portion 24 of the interface gap 22. With this arrangement, cooling fluid 42 will reach the interface gap 22 and provide supplemental cooling. When used in conjunction with the partition members 36 described above, the cooling fluid conduits 40 bring cooling fluid 42 into a region characterized by relatively-low fluid velocity, thereby ensuring an extended cooling fluid residence time and increasing the cooling effectiveness of the fluid. Additionally, cooling fluid 42 introduced through the radially-skewed portion 24 of the interface gap 22 leaves the interface gap with a rotationally-downstream velocity component and tends to blanket the radially-inward surface 54 of the boundary members 12. With this arrangement, cooling fluid 42 leaving the interface gap 22 provides a cooling film that will not only lower the temperature of the blade tips 72, but will also protect the boundary members 12 from prolonged exposure to extreme temperatures.

Although the boundary members 12 have been described as having interface gaps 22 located between interface edges 30,32 of circumferentially-spaced boundary members 12, the boundary member front and rear edges 50,52 may also be contoured to form interface gaps. With contoured boundary member front and rear edges (not shown), the various features described above may be incorporated into interface gaps (not shown) disposed between sets 20 of boundary members spaced apart axially within an engine 18.

It is to be understood that while certain forms of the invention have been illustrated and described, it is not to be limited to the specific forms or arrangement of parts herein described and shown. It will be apparent to those skilled in the art that various, including modifications, rearrangements and substitutions, may be made without departing from the scope of this invention and the invention is not to be considered limited to what is shown in the drawings and described in the specification. The scope if the invention is defined by the claims appended hereto.

1. An outer air seal assembly for reducing leakage proximate a fluid guide component having a predetermined direction of rotation, comprising:
a first boundary member radially spaced apart from a central axis by a predetermined first distance, said first boundary member characterized by a first interface edge and an opposite second interface edge;
a second boundary member radially spaced apart from said central axis by a predetermined second distance, said second boundary member being characterized by a first interface edge and an opposite second interface edge, said second boundary member first edge being disposed proximate said first boundary member second edge and spaced apart therefrom by an interface gap disposed therebetween;
wherein said interface gap includes a radially-skewed portion having a radially-inward region and a radially-outward region, said radially-outward region being rotationally-upstream of said radially-inward region.

2. The outer air seal assembly of claim 1, wherein said interface gap separates said first and second boundary members circumferentially:

3. The outer air seal assembly of claim 2, further including a blocking panel disposed within said interface gap.

4. The outer air seal assembly of claim 2, further including a radially-aligned region disposed radially-outward of said radially-skewed portion.

5. The outer air seal assembly of claim 4, further including a blocking panel disposed within said interface gap.

6. The outer air seal assembly of claim 5, wherein said blocking panel is disposed within said radially-aligned region.

7. The outer air seal assembly of claim 2, further including a partition member extending into said interface gap, wherein a serpentine-shaped pathway is formed within said interference gap.

8. The outer air seal assembly of claim 7, wherein said partition member is disposed on said first boundary member.

9. The outer air seal assembly of claim 7, wherein said partition member is disposed on said second boundary member.

10. The outer air seal assembly of claim 7, wherein said partition member is oriented in a substantially-radially-aligned manner with respect to said central axis.

11. The outer air seal assembly of claim 7, wherein said partition member is oriented in a substantially-circumferentially-aligned manner with respect to said central axis.

12. The outer air seal assembly of claim 2, wherein said first boundary member further includes a radially-inward surface and a conduit adapted to fluidly connect a source of cooling fluid to said interface gap, whereby said interface gap is adapted to deliver cooling fluid to a location proximate said radially-inward surface.

13. The outer air seal assembly of claim 12, wherein said conduit is fluidly connected to said radially-skewed portion.

14. The outer air seal assembly of claim 2, wherein said second boundary member further includes a radially-inward surface and a conduit adapted to fluidly connect a source of cooling fluid to said interface gap, whereby said interface gap is adapted to deliver cooling fluid to a location proximate said radially-inward surface.

15. The outer air seal assembly of claim 14, wherein said conduit is fluidly connected to said radially-skewed portion.

16. An outer air seal assembly for reducing leakage proximate a fluid guide component having a predetermined direction of rotation, comprising:
a first boundary member radially spaced apart from a central axis by a predetermined first distance, said first boundary member characterized by a first interface edge, an opposite second interface edge, and a radially-inward surface;
a second boundary member radially spaced apart from said central axis by a predetermined second distance, said second boundary member being characterized by a first interface edge, an opposite second interface edge, and a radially-inward surface;
said second boundary member first edge being disposed proximate said first boundary member second edge and spaced apart therefrom by an interface gap disposed therebetween;
wherein said interface gap includes a radially-skewed portion having a radially-inward region and a radially-outward region, said radially-outward region being rotationally-upstream of said radially-inward region;
a blocking panel disposed within said interface gap;
a partition member partition member extending into said interface gap, wherein a serpentine shaped pathway is formed within said interference gap; and
a conduit adapted to fluidly connect a source of cooling fluid to said interface gap, wherein said interface gap is adapted to deliver cooling fluid to a location proximate said radially-inward surfaces.

17. The outer air seal assembly of claim 1, wherein said interface gap separates said first and second boundary members axially.

18. The outer air seal assembly of claim 17, further including a radially-aligned region disposed radially-outward of said radially-skewed portion.

19. The outer air seal assembly of claim 17, further including a partition member extending into said interface gap, wherein a serpentine-shaped pathway is formed within said interference gap.

20. The outer air seal assembly, of claim 17, wherein said first boundary member further includes a radially-inward surface and a conduit adapted to fluidly connect a source of cooling fluid to said interface gap, wherein said interface gap is adapted to deliver cooling fluid to a location proximate said radially-inward surface.
